(19) United States
(12) Patent Application Publication
(10) Pub. No.: US 2025/0193328 A1
(43) Pub. Date: Jun. 12, 2025

(54) READING DEVICE, IMAGE PROCESSING APPARATUS, READING METHOD, AND NON-TRANSITORY RECORDING MEDIUM

(71) Applicants: Tomohiko ONO, KANAGAWA (JP); Shogo NAKAMURA, KANAGAWA (JP); Yuji SUZUKI, KANAGAWA (JP); Ayumu HASHIMOTO, KANAGAWA (JP)

(72) Inventors: Tomohiko ONO, KANAGAWA (JP); Shogo NAKAMURA, KANAGAWA (JP); Yuji SUZUKI, KANAGAWA (JP); Ayumu HASHIMOTO, KANAGAWA (JP)

(21) Appl. No.: 18/976,364

(22) Filed: Dec. 11, 2024

(30) Foreign Application Priority Data
Dec. 12, 2023 (JP) 2023-209352

(51) Int. Cl. H04N 1/00; H04N 1/387

(52) U.S. Cl. CPC H04N 1/00809; H04N 1/00787; H04N 1/3878; H04N 2201/0081

(57) ABSTRACT

A reading device includes: a light source to emit light to a subject; an imaging device to receive light reflected from the subject and generate an image; a first inclination correction device to mechanically correct an inclination of the subject; a second inclination correction device to electronically correct an inclination of the image obtained at the imaging device; and circuitry to: switch to use between the first inclination correction device and the second inclination correction device. In a case where the subject includes subjects of a single size but does not include subjects of multiple sizes, the circuitry switches to use the first inclination correction device, and in a case where the subject includes subjects of multiple sizes, the circuitry switches to use the second inclination correction device.

### CROSS-REFERENCE TO RELATED APPLICATIONS

This patent application is based on and claims priority pursuant to 35 U.S.C. § 119 (a) to Japanese Patent Application No. 2023-209352, filed on Dec. 12, 2023, in the Japan Patent Office, the entire disclosure of which is hereby incorporated by reference herein.

### BACKGROUND

### Technical Field

The present disclosure relates to a reading device, an image processing apparatus, a reading method, and a non-transitory recording medium.

### Related Art

A reading device of the related art includes a conveyance device that conveys a subject (e.g., a document), and mechanically or electronically corrects an inclination of a read image of the subject being conveyed.

For example, the timing of deceleration of conveyance rollers is set to be delayed to increase the amount of abutment of the leading edge of a subject (e.g., a document) conveyed by the conveyance rollers. Accordingly, mechanical inclination correction is effectively performed on a small-sized document when documents of multiple different sizes are read.

### SUMMARY

According to an embodiment of the present disclosure, a reading device induces a light source, an imaging device, a first inclination correction device, a second inclination correction device, and circuitry. The light source emits light to a subject. The imaging device receives light reflected from the subject and generates an image. The first inclination correction device mechanically corrects an inclination of the subject. The second inclination correction device electronically corrects an inclination of the image obtained at the imaging device. The circuitry switches to use between the first inclination correction device and the second inclination correction device. The circuitry switches to use the first inclination correction device in a case where the subject includes subjects of a single size but does not include subjects of multiple sizes. The circuitry switches to use the second inclination correction device in a case where the subject includes subjects of multiple sizes.

According to an embodiment of the present disclosure, an image processing apparatus includes the above-described reading device and an image forming device that forms the image.

According to an embodiment of the present disclosure, a reading method includes emitting light to a subject; reading, by the imaging device, light reflected from the subject to generate an image; and switching to use between a first inclination correction device to mechanically correct an inclination of the subject and a second inclination correction device to electronically correct an inclination of the image. The switching includes switching to use the first inclination correction device in a case where the subject includes subjects of a single size but does not include subjects of multiple sizes, and switching to use the second inclination correction device in a case where the subject includes subjects of multiple sizes.

According to an embodiment of the present disclosure, a non-transitory recording medium stores a plurality of instructions which, when executed by one or more processors, causes the processors on a reading device to perform a method. The reading device includes a light source, an imaging device, a first inclination correction device, and a second inclination correction device. The light source emits light to a subject. The imaging device receives light reflected from the subject and generates an image. The first inclination correction device mechanically corrects an inclination of the subject. The second inclination correction device electrically corrects an inclination of the image obtained at the imaging device. The method includes switching between the first inclination correction device and the second inclination correction device, the switching including switching to use the first inclination correction device in a case where the subject includes subjects of a single size but does not include subjects of multiple sizes, and switching to use the second inclination correction device in a case where the subject includes subjects of multiple sizes.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example configuration of an image forming apparatus according to a first embodiment of the present disclosure;

FIG. 2 is a diagram illustrating an example configuration of an image reading device according to the first embodiment of the present disclosure;

FIG. 3 is a diagram illustrating an example arrangement of a mechanical inclination correction device according to the first embodiment of the present disclosure;

FIG. 4 is a diagram illustrating an example configuration of a reader according to the first embodiment of the present disclosure;

FIG. 5 is a block diagram illustrating electrical connections of components of the image reading device according to the first embodiment of the present disclosure;

FIG. 6 is a block diagram illustrating a functional configuration of the components of the image reading device according to the first embodiment of the present disclosure;

FIG. 7 is a graph illustrating a difference in spectral reflection characteristics between media according to the first embodiment of the present disclosure;

FIG. 8 is a diagram illustrating an example of a difference between a visible image and an invisible image;

FIG. 9 is a diagram illustrating an example of edge detection of a subject;

FIG. 10 is a diagram illustrating an example of correction of an inclination of a document;

FIG. 11 is a diagram illustrating an example of information obtained from the edge of the subject;

FIG. 12A and FIG. 12B are diagrams illustrating examples of a method for edge detection;

FIG. 13A and FIG. 13B are diagrams illustrating an example of a feature value using an edge;

FIG. 14 is a diagram illustrating an example of the selection of a line equation for a regression line equation;

FIG. 15 is a diagram illustrating an example configuration of an image reading device of the related art;

FIG. 16 is a diagram illustrating an example contact between the edge of a document and a roller in the image reading device of the related art;

FIG. 17 is a diagram illustrating an example in which mechanical inclination correction is not effective in the image reading device of the related art;

FIG. 18 is a flowchart schematically illustrating an image reading process according to the first embodiment of the present disclosure;

FIG. 19 is a diagram illustrating an example of a display form on an operation device of the image reading device according to the first embodiment of the present disclosure;

FIG. 20 is a diagram illustrating an example in which electronic inclination correction by an electronic inclination correction device is not effective;

FIG. 21 is a block diagram illustrating a functional configuration of components of an image reading device according to a second embodiment of the present disclosure;

FIG. 22 is a diagram illustrating an example arrangement of a document width sensor according to the second embodiment of the present disclosure;

FIG. 23 is a flowchart schematically illustrating an image reading process according to the second embodiment of the present disclosure;

FIG. 24 is a diagram illustrating another example arrangement of the document width sensor according to the second embodiment of the present disclosure;

FIG. 25 is a diagram illustrating another example arrangement of the document width sensor according to the second embodiment of the present disclosure;

FIG. 26A, FIG. 26B, and FIG. 26C are diagrams illustrating reading devices according to modifications of the first and second embodiments of the present disclosure; and

FIG. 27 is a diagram illustrating a reading device according to another modification of the first and second embodiments of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A reading device, an image processing apparatus, a reading method, and a program according to one or more embodiments of the present disclosure will be described in detail hereinafter with reference to the accompanying drawings.

### First Embodiment

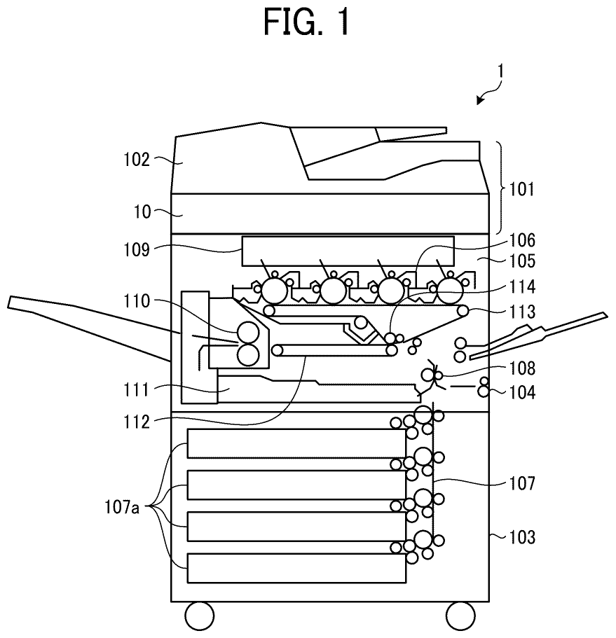

FIG. 1 is a diagram illustrating an example configuration of an image forming apparatus 1 according to a first embodiment of the present disclosure. In FIG. 1, the image forming apparatus 1, which is an example of an image processing apparatus, is typically called a multifunction peripheral (MFP) having at least two of copying, printing, scanning, and facsimile functions.

The image forming apparatus 1 includes an image reading device 101, which is an example of a reading device, and an image forming device 103 below the image reading device 101. In FIG. 1, the image forming device 103 is uncovered to reveal the internal configuration of the image forming device 103 to describe the internal configuration of the image forming device 103.

The image reading device 101 includes an automatic document feeder (ADF) 102 atop a device body 10 of the image reading device 101. The ADF 102 is a document support device that positions, at a reading position, a document including an image to be read. The ADF 102 automatically feeds a document placed on a document feed table to the reading position.

The image reading device 101 reads the document fed by the ADF 102 at a predetermined reading position. The image reading device 101 includes an exposure glass on a top surface of the image reading device 101. The exposure glass serves as a document support device on which a document is placed. The image reading device 101 reads the document on the exposure glass, that is, at the reading position. Specifically, the image reading device 101 is a scanner including a light source, an optical system, and a solid-state imaging element such as a complementary metal oxide semiconductor (CMOS) image sensor inside the scanner. The document is irradiated with light emitted from the light source, and light reflected from the document is read by the solid-state imaging element through the optical system.

The image forming device 103 includes a manual feed roller pair 104 that receives a manually fed recording medium, and a recording medium supply device 107 that supplies a recording medium. The recording medium supply device 107 includes an assembly that feeds recording media one by one from vertically-aligned input trays 107a. The supplied recording medium is sent to a secondary transfer belt 112 via a registration roller pair 108.

The recording medium conveyed along the secondary transfer belt 112 is sent to a transfer device 114. In the transfer device 114, a toner image on an intermediate transfer belt 113 is transferred onto the recording medium.

The image forming device 103 further includes an optical writing device 109, tandem image formation devices 105 for yellow (Y), magenta (M), cyan (C), and black (K) colors, the intermediate transfer belt 113, and the secondary transfer belt 112. In the image forming device 103, each of the image formation devices 105 performs a process of image formation to render a latent image, which is written by the optical writing device 109, visible as a toner image and form the toner image on the intermediate transfer belt 113.

Specifically, the image formation devices 105 for the Y, M, C, and K colors include rotatable drum-shaped photoconductors for the Y, M, C, and K colors, respectively. Each of the four photoconductors is surrounded by image formation elements 106 including a charging roller, a developing device, a primary transfer roller, a cleaner device, and a static eliminator. The image formation elements 106 function around each of the four photoconductors to form an image on the corresponding photoconductor. The images on the photoconductors are transferred onto the intermediate transfer belt 113 by the corresponding primary transfer rollers.

The intermediate transfer belt 113 is stretched across a drive roller and a driven roller and disposed so as to pass through nips between the photoconductors and the corresponding primary transfer rollers. As the intermediate transfer belt 113 rotates, the toner images primarily transferred onto the intermediate transfer belt 113 are conveyed to a secondary transfer device to secondarily transfer the toner images onto a recording medium on the secondary transfer belt 112 to form a composite toner image on the recording medium. As the secondary transfer belt 112 rotates, the recording medium is conveyed to a fixing device 110. The fixing device 110 fixes the composite toner image on the recording medium as a color image. Then, the recording medium is discharged to an output tray outside the image forming device 103. In the case of double-sided or duplex printing, a reverse assembly 111 reverses the recording medium upside down, and the reversed recording medium is fed onto the secondary transfer belt 112.

The image forming device 103 is not limited to the one that forms an image by electrophotography as described above. The image forming device 103 may be one that forms an image by an inkjet method.

Next, the image reading device 101 will be described.

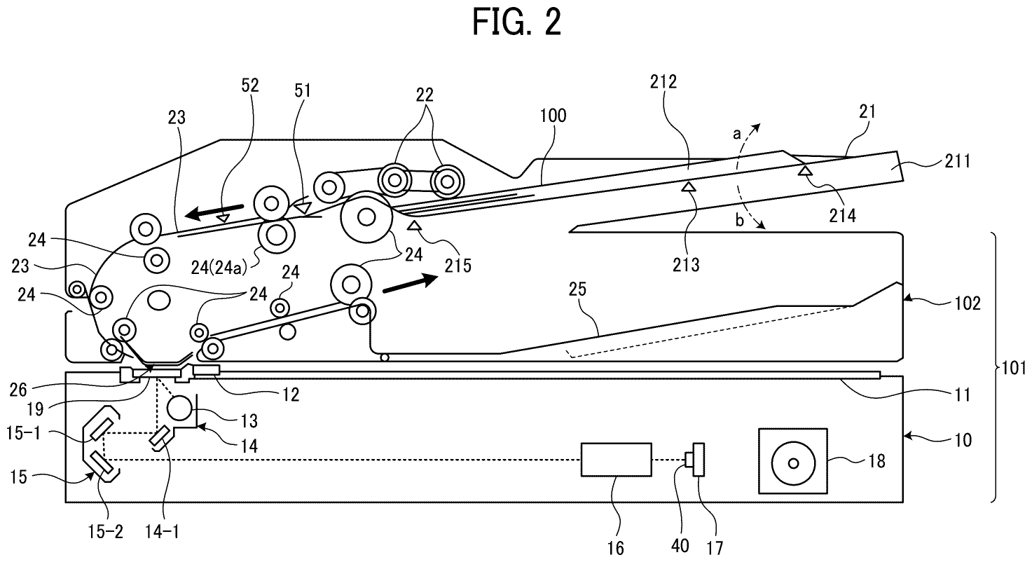

FIG. 2 is a diagram illustrating an example configuration of the image reading device 101. The image reading device 101 includes an exposure glass 11 on a top surface of the device body 10. The image reading device 101 includes, inside the device body 10, for example, a light source 13, a first carriage 14, a second carriage 15, a lens device 16, and a sensor board 17. In FIG. 2, the first carriage 14 includes the light source 13 and a mirror 14-1, and the second carriage 15 includes mirrors 15-1 and 15-2.

The light source 13 emits light to a reading target. Light reflected from the reading target is reflected by the mirror 14-1 of the first carriage 14 and the mirrors 15-1 and 15-2 of the second carriage 15 and enters the lens device 16. Accordingly, an image of the reading target is formed on a light-receiving surface on the sensor board 17 from the lens device 16. The sensor board 17 includes an imaging device 40. The imaging device 40 is a line sensor such as a charge coupled device (CCD) sensor or a CMOS sensor. The imaging device 40 sequentially converts the image of the reading target formed on the light-receiving surface on the sensor board 17 into electrical signals. A reference white plate 12 is a white density reference member to be read to correct, for example, the change in the light level of the light source 13 or the variation in pixels (pixel circuits) of the imaging device 40.

In the image reading device 101, the device body 10 is provided with a control board to control the components of the device body 10 and the components of the ADF 102 to read the reading target by a predetermined reading method. An example of the reading target is a recording medium on which characters, a picture, or the like is formed. The recording medium is hereinafter referred to as a document. The document corresponds to a “subject” and is described as, for example, but not limited to, paper or a transparent sheet (such as an overhead projector (OHP) sheet).

The image reading device 101 reads documents 100 by a sheet-through method using the ADF 102. The ADF 102 is an example of a “conveyance device”. In the configuration illustrated in FIG. 2, the image reading device 101 separates a bundle of documents 100 placed on a tray 21 of the ADF 102 one by one by pickup rollers 22 and conveys the separated document 100 to a conveyance path 23. The image reading device 101 reads a surface to be read of the document 100 at a reading position of a reader and discharges the document 100 to an output tray 25. The document 100 is conveyed by rotation of various conveyance rollers 24.

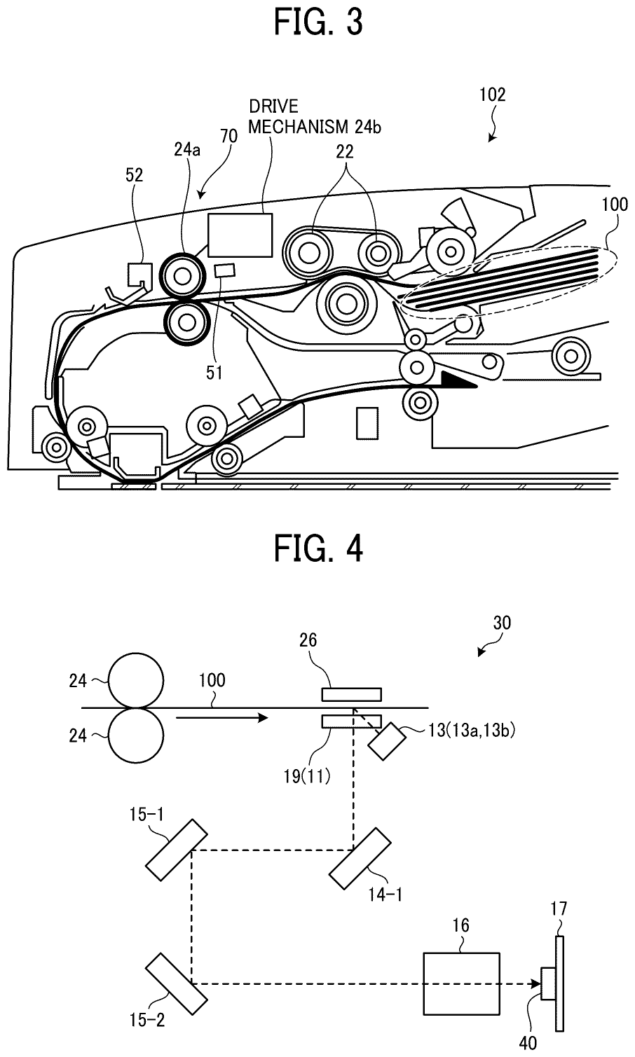

The various conveyance rollers 24 include a pullout roller pair 24a. The pullout roller pair 24a is a pair of rollers for performing primary edge registration (so-called skew correction) on the fed document 100 and pulling out and conveying the document 100 after the registration. A contact sensor 51 is provided near the pullout roller pair 24a. The pullout roller pair 24a and a drive mechanism 24b (see FIG. 3) including a drive circuit are included in a mechanical inclination correction device 70. The mechanical inclination correction device 70 is a first inclination correction device.

FIG. 3 is a diagram illustrating an example arrangement of the mechanical inclination correction device 70. As illustrated in FIG. 3, the mechanical inclination correction device 70 according to the present embodiment includes, for example, the pullout roller pair 24a (abutment member) provided on the conveyance path 23 along which the document 100 is conveyed. In one example, the operation of the pullout roller pair 24a is controlled by the drive mechanism 24b.

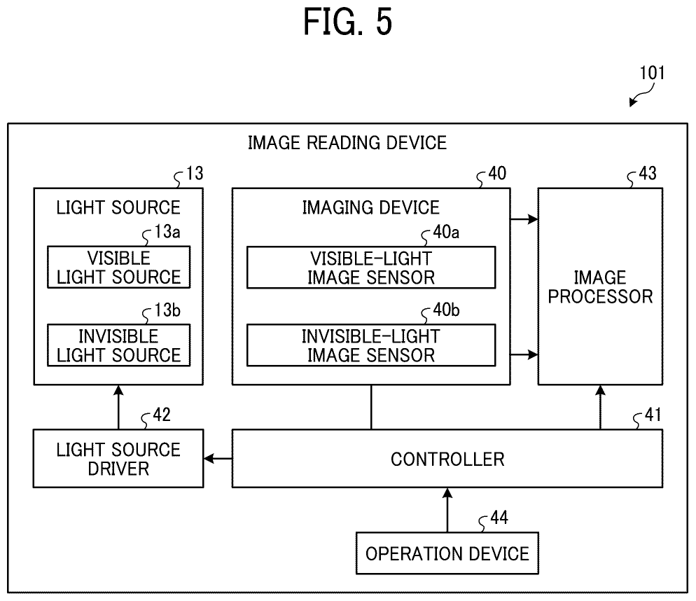

In response to an instruction from a controller 41 (see FIG. 5) to enable the mechanical inclination correction device 70, the mechanical inclination correction device 70 stops the rotation of the pullout roller pair 24a for abutment under the control of the drive mechanism 24b. Accordingly, the mechanical inclination correction device 70 brings the leading edge of the document 100 into contact with the nip of the pullout roller pair 24a to bend the document 100 to correct the inclination of the document 100.

In response to an instruction from the controller 41 (see FIG. 5) to disable the mechanical inclination correction device 70, in contrast, the mechanical inclination correction device 70 keeps the pullout roller pair 24a rotating under the control of the drive mechanism 24b or increases the gap between the pullout roller pair 24a under the control of the drive mechanism 24b. Accordingly, the mechanical inclination correction device 70 conveys the document 100 without stopping the document 100 at the pullout roller pair 24a for abutment.

Referring back to FIG. 2, the tray 21 includes a movable document table 211 that rotates about a proximal end thereof in directions a and b in FIG. 2, and a pair of side guide plates 212 that positions the documents 100 in the left-right direction with respect to a document-feeding direction of the documents 100. The movable document table 211 is rotated to adjust the front edges of the documents 100 in the document-feeding direction to an appropriate height.

Further, the tray 21 is provided with document length detection sensors 213 and 214 to detect whether the documents 100 are oriented vertically or horizontally. The document length detection sensors 213 and 214 are provided to be spaced apart from each other in the document-feeding direction. The document length detection sensors 213 and 214 may be reflective sensors that perform non-contact detection using optical means or may be contact actuator-type sensors.

The pair of side guide plates 212 is slidable to the right and left with respect to the document-feeding direction and is configured to support documents 100 of different sizes placed on the tray 21. The pair of side guide plates 212 is provided with a document set sensor 215 to detect the placement of the documents 100 on the tray 21.

A document width sensor 52 serving as a subject size detector is provided on the conveyance path 23 downstream of the pullout roller pair 24a in the conveyance direction of the documents 100.

The image reading device 101 causes each of the documents 100 to pass through a gap between a reading window 19 and a background device 26 with, for example, the first carriage 14 and the second carriage 15 moved to and secured at predetermined home positions. The reading window 19 is a reading slit provided in a portion of the exposure glass 11. The background device 26 is a member positioned to face the reading window 19. The reader emits light from the light source 13 to a first surface (a front side or a back side) of the document 100 facing the reading window 19 while the document 100 passes through the reading window 19, and receives reflected light at the imaging device 40 on the sensor board 17 to read an image of the document 100. The background device 26 has a size that is included in an imaging range of the imaging device 40. Examples of the background device 26 include a sheet metal and a roller.

In the following description, for example, the light source 13, the background device 26, the optical system (such as the mirror 14-1, the mirrors 15-1 and 15-2, and the lens device 16) that guides the light reflected from the document 100 to the imaging device 40 on the sensor board 17, and the imaging device 40 are included in a reader (first reader). The configuration of the reader will be described below with reference to FIG. 5.

For double-sided reading of the document 100, for example, a reverse assembly is provided to reverse the document 100 upside down. The image reading device 101 includes the reverse assembly to reverse the document 100 upside down and causes the reader to read a second surface (the back side or the front side) of the document 100 at the reading position (i.e., the reading window 19) of the reader. Instead of the reverse assembly, another element, for example, a second reader, may be provided to read the second surface of the document 100. For example, after the document 100 passes through the reading window 19, a reader (i.e., the second reader) including a reading sensor adjacent to the back side of the document 100 reads the second surface of the document 100. In this case, the background device 26 (see FIG. 4) is a member positioned to face the reading sensor.

In the present embodiment, the image reading device 101 also supports flatbed scanning. Specifically, the user lifts up the ADF 102 to expose the exposure glass 11 and places a document 100 directly on the exposure glass 11. Then, the user lowers the ADF 102 to the original position such that the back side of the document 100 is pressed by a lower portion of the ADF 102. In the flatbed scanning, the document 100 is fixed. Thus, the carriages (the first carriage 14 and the second carriage 15) are moved with respect to the document 100 to perform scanning. The first carriage 14 and the second carriage 15 are driven by a scanner motor 18 to scan the document 100 in a sub-scanning direction. For example, the first carriage 14 moves at a speed V, and, at the same time, the second carriage 15 moves at a speed 1/2V, which is half the speed of the first carriage 14, in conjunction with the movement of the first carriage 14 to read the first surface of the document 100 on the exposure glass 11. In this case, the lower portion of the ADF 102 (i.e., a member that presses the back side of the document 100) corresponds to the background device 26 (see FIG. 4).

In the illustrated example, for example, the first carriage 14, the second carriage 15, the lens device 16, and the sensor board 17 are illustrated as separate devices. In another example, these devices may be provided individually or may be provided as an integrated sensor module.

FIG. 4 is a diagram illustrating an example configuration of a reader 30. FIG. 4 illustrates, as an example, the configuration of the reader 30 (i.e., the first reader) that reads the first surface of the document 100, and a conveyance mechanism. As illustrated in FIG. 4, the document 100 is fed by the various conveyance rollers 24 and passes through the gap between the reading position (i.e., the reading window 19) of the exposure glass 11 and the background device 26.

The reader 30 has the background device 26 to be paired with the reading window 19. In response to the light source 13 being turned on, the first surface of the document 100 facing the reading window 19 is irradiated with light from the light source 13 while the document 100 passes through the reading window 19, and the light reflected from the first surface of the document 100 travels along a path indicated by a dotted line in FIG. 4. The reflected light is then received by the imaging device 40 on the sensor board 17 to read an image of the document 100.

The configuration of the reader 30 is not limited to the illustrated configuration of the first reader. The reader 30 may be a reader that uses a contact image sensor, such as the second reader, or, alternatively, may be modified as appropriate in accordance with the configuration of the image reading device 101.

As illustrated in FIG. 4, the light source 13 according to the present embodiment is an illumination device including a visible light source 13a and an invisible light source 13b to emit visible light and invisible light to a subject. The visible light source 13a emits visible light to the subject and the background device 26. The invisible light source 13b emits invisible light to the subject and the background device 26. It is effective to use an infrared light source as the invisible light source 13b. In general, a visible light wavelength ranges between 380 nm and 750 nm, and the range of wavelengths equal to or greater than 750 nm is the infrared wavelength range, which is the range of wavelengths of invisible light.

In the present embodiment, the invisible light source 13b emits invisible light in the infrared wavelength range equal to or greater than 750 nm, for example but not limitation. In another example, the invisible light source 13b may emit invisible light in an ultraviolet wavelength range equal to or less than 380 nm.

FIG. 5 is a block diagram illustrating electrical connections of components of the image reading device 101. As illustrated in FIG. 5, the image reading device 101 includes the imaging device 40 and the light source 13 described above. The image reading device 101 further includes the controller 41, a light source driver 42, an image processor 43, and an operation device 44. The controller 41 controls the imaging device 40, the light source driver 42, the image processor 43, and the operation device 44. The light source driver 42 drives the light source 13 under the control of the controller 41. The imaging device 40 transfers a signal to the image processor 43 disposed downstream of the imaging device 40. An example of the operation device 44 is a display with a touch panel.

The imaging device 40 includes an invisible-light image sensor 40b serving as an invisible image reader and a visible-light image sensor 40a serving as a visible image reader. The imaging device 40 receives visible light and invisible light reflected from the subject and captures a visible image and an invisible image. More specifically, the invisible-light image sensor 40b reads invisible reflected light, which is a portion of the invisible light, from the subject to acquire an invisible image. The invisible image is an image in the invisible light wavelength range. The visible-light image sensor 40a reads visible reflected light, which is a portion of the visible light, from the subject to acquire a visible image. The visible image is an image in the visible light wavelength range. The invisible-light image sensor 40b and the visible-light image sensor 40a are small optical system sensors. In one example, the invisible-light image sensor 40b and the visible-light image sensor 40a are CMOS image sensors.

The visible-light image sensor 40a and the invisible-light image sensor 40b may be integrated with each other. Accordingly, a more compact configuration is achieved, and the position for reading visible light and the position for reading infrared light are closer to each other. Thus, lost information can be extracted and restored with high accuracy. That is, the misalignment of an image caused by reading the image a plurality of times does not occur, and the image can be corrected with high positional accuracy.

The image processor 43 executes various types of image processing according to the purpose of using image data. The controller 41 and the image processor 43 may be implemented by a hardware circuit or may be implemented by a central processing unit (CPU) executing a program.

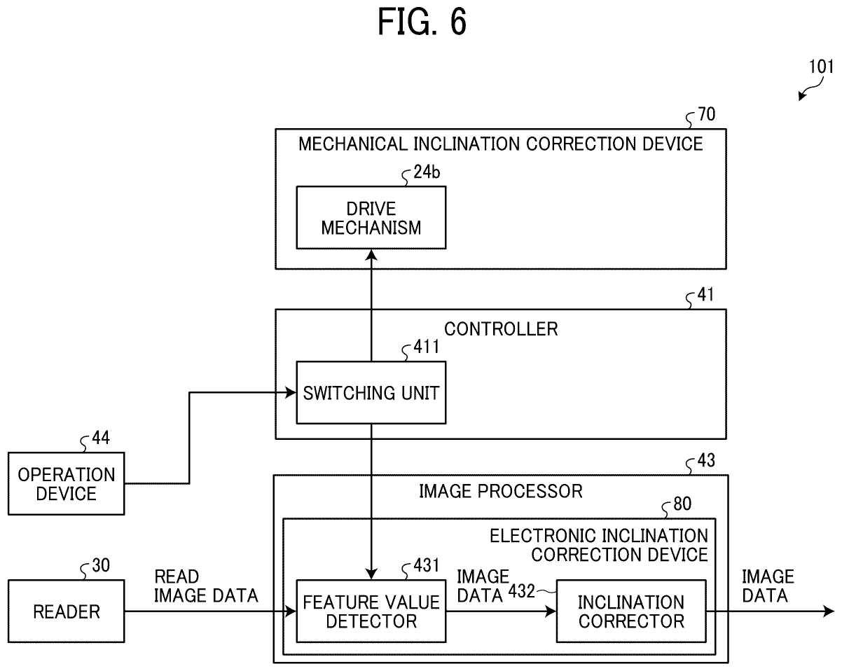

FIG. 6 is a block diagram illustrating a functional configuration of the components of the image reading device 101. As illustrated in FIG. 6, the image processor 43 includes a feature value detector 431 and an inclination corrector 432. The inclination corrector 432 and the feature value detector 431 are included in an electronic inclination correction device 80. The electronic inclination correction device 80 is a second inclination correction device.

In the image processor 43, the feature value detector 431 detects a feature value of the subject or the background device 26 from at least one of the visible image and the invisible image obtained by the image reading device 101. Examples of the feature value include an edge between the background device 26 and the document 100. The image processor 43 uses the detected feature value to correct the image itself, which will be described in detail below.

The feature value detector 431 serves as an edge detector that detects an edge of the subject in a main scanning direction. More specifically, the feature value detector 431 performs edge detection by a method such as detecting an edge from a difference in density between the read document 100 and the background device 26 or detecting a shadow between the document 100 and the background device 26. The feature value detector 431 identifies a point at which the amount of change in the density of the image exceeds a predetermined value as the edge of the document 100. The term “edge detection” refers to detection of edges of the left and right sides of the document 100 or detection of an edge of the upper side of the document 100 in a detectable range of a main scanning area.

The inclination corrector 432 receives the result of the edge detection from the feature value detector 431 and corrects the inclination of the document 100.

The difference in spectral reflection characteristics between media in the imaging device 40 is now described.

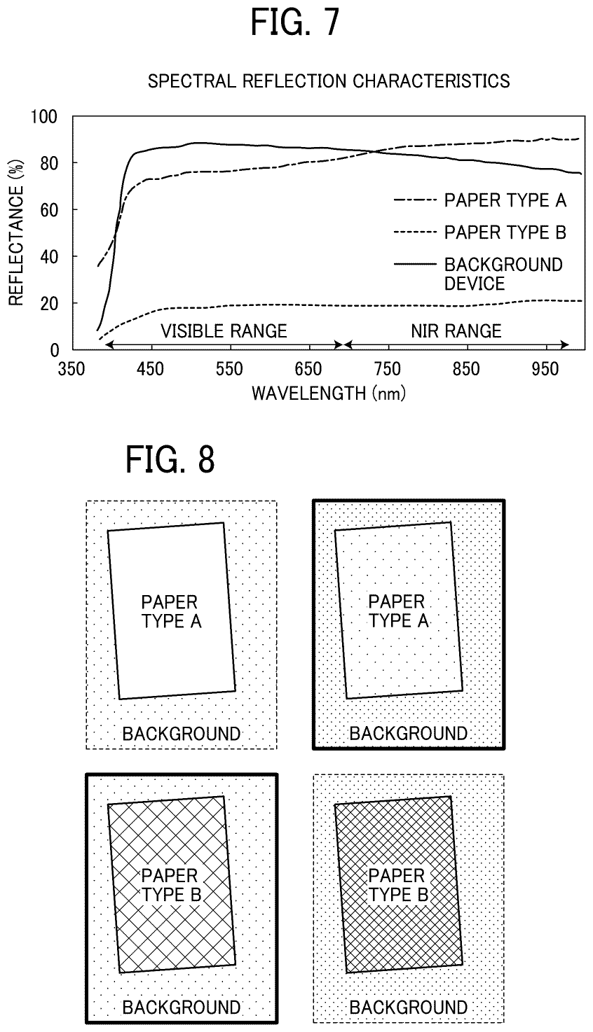

FIG. 7 is a graph illustrating a difference in spectral reflection characteristics between media. FIG. 7 illustrates the spectral reflection characteristics of two types of plain paper commonly used as documents to be read by the image reading device 101, namely, paper types A and B, and the background device 26. In the graph illustrated in FIG. 7, a dash-dotted line indicates the spectral reflection characteristics of plain paper (the paper type A), a dotted line indicates the spectral reflection characteristics of plain paper (the paper type B), and a solid line indicates the spectral reflection characteristics of the background device 26.

As illustrated in FIG. 7, the reflectance of the background device 26, which is a white background, is higher than that of the plain paper (the paper type A) in the visible wavelength range, but is lower than that of the plain paper (the paper type A) in the near-infrared (NIR) wavelength range.

As illustrated in FIG. 7, furthermore, the reflectance of the background device 26 is higher than that of the plain paper (the paper type B) in both the visible wavelength range and the NIR wavelength range.

FIG. 8 is a diagram illustrating an example of a difference between a visible image (left) and an invisible image (right). As illustrated in FIG. 8, when the imaging device 40 reads reflected light, the background device 26 and the document 100 have different spectral reflection characteristics, and images having different feature values are obtained for visible light and invisible light. Thus, if an image to be detected is set in advance from either a visible image or an invisible image in accordance with the type of the subject or the type of the background device 26, an intended feature value is easily obtained.

For example, in the example illustrated in FIG. 8, an invisible image of the paper type A (right) has a larger difference in spectral reflection characteristic from the background device 26 than a visible image (left) of the paper type A. In the case of the paper type A, accordingly, an invisible image (right) is set as the target for detecting the feature value. Conversely, a visible image (left) of the paper type B has a larger difference in spectral reflection characteristic from the background device 26 than an invisible image (right) of the paper type B. In the case of the paper type B, accordingly, a visible image (left) is set as the target for detecting the feature value.

The feature value may be extracted from either a visible image or an invisible image, or feature values may be extracted from both a visible image and an invisible image and the results of the extraction may be integrated or a result may be selected from the results.

Subsequently, an example of edge detection of the document 100, which is a subject, by the feature value detector 431 and an example of correction of the inclination of the document 100 by the inclination corrector 432 are described.

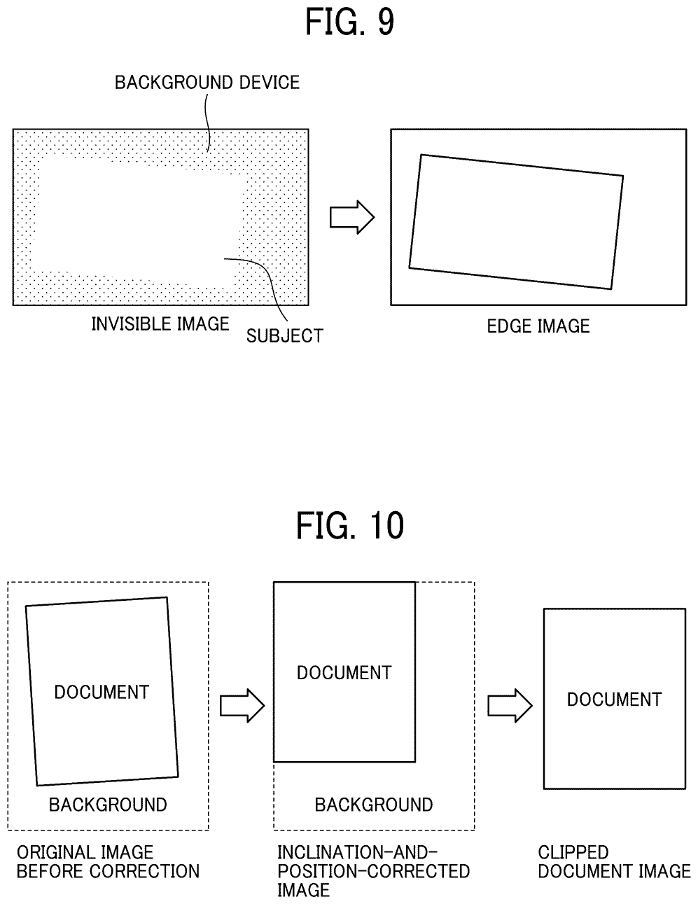

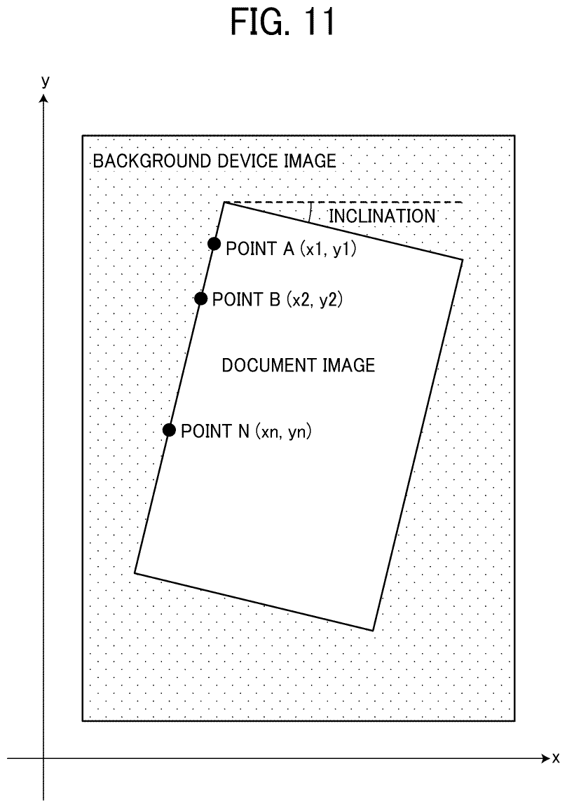

FIG. 9 is a diagram illustrating an example of edge detection of a subject. FIG. 10 is a diagram illustrating an example of correction of an inclination of a document. FIG. 11 is a diagram illustrating an example of information obtained from the edge of the subject. As illustrated in FIG. 9, for example, it is desirable to reduce the reflectance of the background device 26 and use an invisible image to extract the edge between the background device 26 and the document 100 from the image. As illustrated in FIG. 10, it is also desirable to reduce the reflectance of the background device 26 and use an invisible image to correct the inclination and the position of the document or clip a document image. As described above, when the document 100 is read with invisible light, an image having a bright portion corresponding to the document 100 and a dark portion corresponding to the background device 26 is obtained because the background device 26 has a low invisible light reflectance. Since the difference between the document 100 and the background device 26 is clear, the edge is easily detected. That is, the difference in density between the document 100 and the background device 26 is increased, providing more accurate edge detection.

As illustrated in FIG. 11, the edge represents the boundary between the document 100, which is a subject, and the background device 26. The edge is detected to recognize, for example, the position, inclination, and size of the document 100, which is a subject, as illustrated in FIG. 11.

More specifically, the inclination corrector 432 extracts the edge (end portion) of a document area based on the feature value (edge) of the image detected by the feature value detector 431 and calculates the angle of the inclination of the document from the coordinates of the end portion. In one example, the inclination corrector 432 calculates the inclination of the document area from the positions of the pixels in the edge. For example, as illustrated in FIG. 11, the inclination corrector 432 sets the inclination of a straight line to, for example, (yn−y1)/(xn−x1) to calculate the inclination of the regression line of the edge. The inclination corrector 432 may determine the inclination by another method such as a method of determining the inclination of the regression line of the edge by using the least-squares method.

The inclination corrector 432 applies a rotation process to an image portion corresponding to the document area, based on the calculated angle of the inclination of the edge and provides a read image equivalent to that obtained without the inclination of the document.

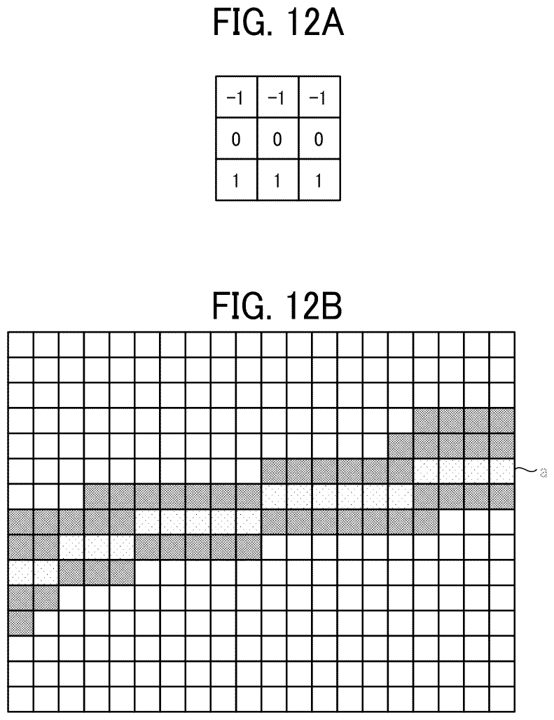

FIGS. 12A and 12B are diagrams illustrating examples of a method for edge detection. An example of a method for edge detection is illustrated in FIG. 12A. In the method illustrated in FIG. 12A, for example, a first derivative filter is applied to an entire image, and each pixel is binarized depending on whether the pixel has a value exceeding a predetermined threshold. Depending on the threshold, the edge in the horizontal direction may extend vertically across several consecutive pixels (or vice versa). This is because the edge is blurred due to the modulation transfer function (MTF) characteristics of the optical system. To address this problem, in a method as illustrated in FIG. 12B, for example, a pixel (a portion a illustrated in FIG. 12B) that is at the center of the consecutive pixels is selected to obtain a representative edge pixel for, for example, the calculation of a regression line equation described below or size detection.

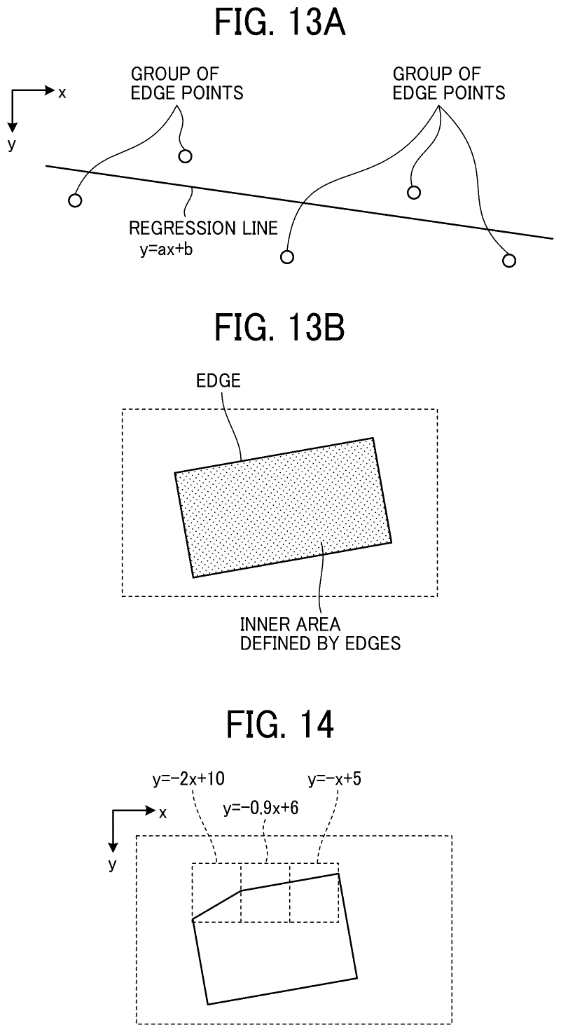

FIGS. 13A and 13B are diagrams illustrating an example of a feature value using an edge. In one example, the feature value is not the edge itself, which is extracted from the image, but may be obtained using the edge. For example, as illustrated in FIGS. 13A and 13B, a regression line equation calculated from groups of extracted edge points by using, for example, the least-squares method, or an inner area defined by edges (aggregate of positions) may be used. The regression line equation may be obtained by determining one line equation from information on all the edges of the respective sides or calculating line equations for a plurality of areas and selecting a representative one of the line equations or integrating representative ones of the line equations. Examples of a method for deriving a final line equation in this case include a method for determining the line with the median slope value and a method for deriving the mean value of the line equations.

FIG. 14 is a diagram illustrating an example of the selection of a line equation for a regression line equation. Line equations are calculated for a plurality of areas, and a representative one of the line equations is selected or representative ones of the line equations are integrated. This process allows the inclination of the document 100, which is a subject, to be accurately recognized even in a case where, as illustrated in FIG. 14, the document 100 is damaged, such as when portions of the edges of the document 100, which is a subject, are lost.

As in the process described above, the feature value detector 431 extracts the edges of the document 100, which is a subject, as a feature value. As a result, an area of the document 100, which is a subject, can be detected.

As illustrated in FIG. 6, the controller 41 includes a switching unit 411.

The switching unit 411 switches between the mechanical inclination correction device 70 and the electronic inclination correction device 80. More specifically, the switching unit 411 uses the mechanical inclination correction device 70 when the documents 100, which are subjects, are of the same size but not of multiple sizes, and uses the electronic inclination correction device 80 when the documents 100 are of multiple sizes.

An image reading device of the related art has a problem in that document damage is likely to occur when documents of multiple different sizes (documents of mixed sizes) are read. This problem is now described.

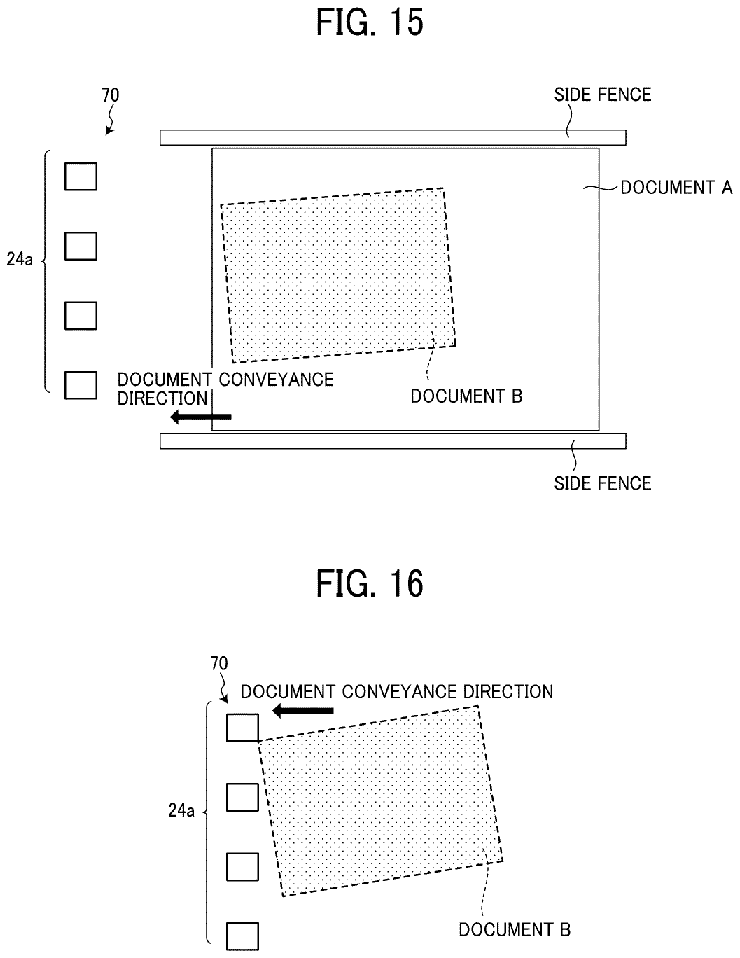

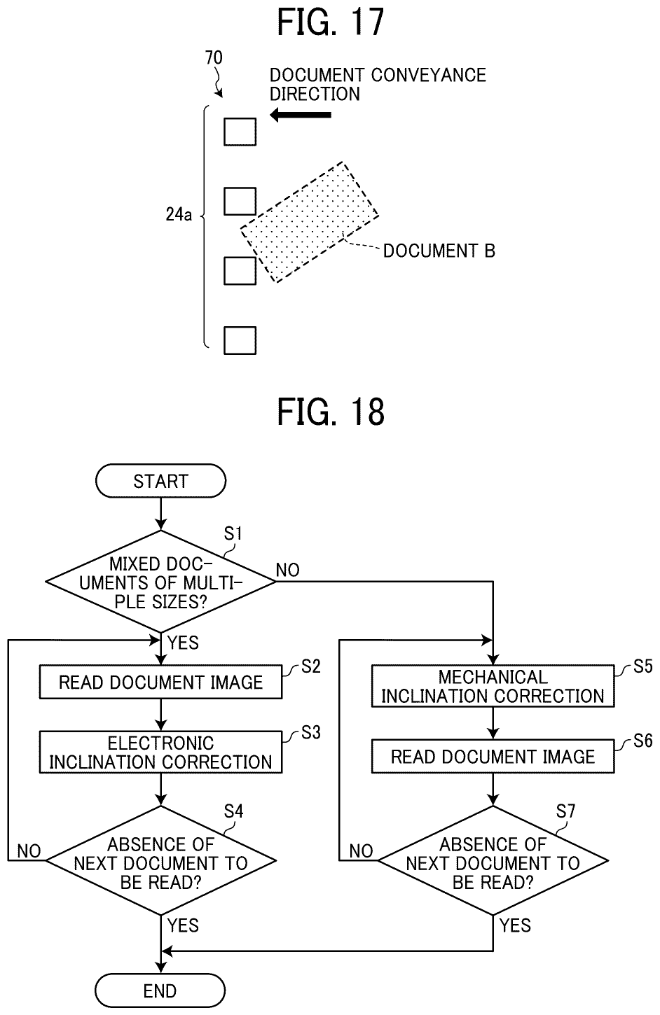

FIG. 15 is a diagram illustrating an example configuration of the image reading device of the related art. FIG. 16 is a diagram illustrating an example contact between the edge of a document and a roller in the image reading device of the related art. FIG. 17 is a diagram illustrating an example in which mechanical inclination correction is not effective in the image reading device of the related art.

As illustrated in FIG. 15, the image reading device of the related art includes a document placement device, and the document placement device is provided with a member (side fences in the example illustrated in FIG. 15) that surrounds both edges of a document placed on the document placement device, and the mechanical inclination correction device 70 (e.g., the pullout roller pair 24a) to address the inclination of the document. In the example illustrated in FIG. 15, when documents of multiple sizes are read, a document having the largest size (e.g., a document A illustrated in FIG. 15) can benefit from the effects of the side fences, whereas a document B having a smaller size than the document A does not benefit from the effect of the side fences to address the inclination of the document B. The document B may be inclined or may even be displaced from the correct placement position.

In the related art, as illustrated in FIG. 15, the mechanical inclination correction device 70 is provided with, for example, pullout roller pairs 24a (including multiple rollers) along the width of the documents such that each of the documents conveyed is brought into contact with any one or more of the pullout roller pairs 24a to correct the inclination of the document. The widths and locations of the pullout roller pairs 24a are determined based on, for example, the processing accuracy of components and the expected sizes of documents to be read.

This configuration has the following two problems.

First, depending on the displacement or inclination of the placed document, the document may be damaged due to the contact with the mechanical inclination correction device 70 (see FIG. 16).

Second, depending on the displacement or size of the placed document, the inclination of the document may be insufficiently corrected by mechanical inclination correction using the mechanical inclination correction device 70 (see FIG. 17).

Accordingly, the image reading device 101 according to the present embodiment includes the mechanical inclination correction device 70 and the electronic inclination correction device 80. In addition, the image reading device 101 according to the present embodiment includes the switching unit 411 that switches whether to activate the two inclination correction devices (i.e., the mechanical inclination correction device 70 and the electronic inclination correction device 80).

The switching unit 411 performs the following control. More specifically, the switching unit 411 does not use the mechanical inclination correction device 70, but uses the electronic inclination correction device 80 at the time of reading documents of mixed sizes. The switching unit 411 uses the mechanical inclination correction device 70 except at the time of reading documents of mixed sizes. Accordingly, the image reading device 101 corrects an inclination of a document while avoiding document damage that is likely to occur when documents of mixed sizes are read. An image reading process performed by the image reading device 101 is described in detail hereinafter.

FIG. 18 is a flowchart schematically illustrating the image reading process. As illustrated in FIG. 18, the switching unit 411 determines whether documents of multiple sizes are mixed (step S1).

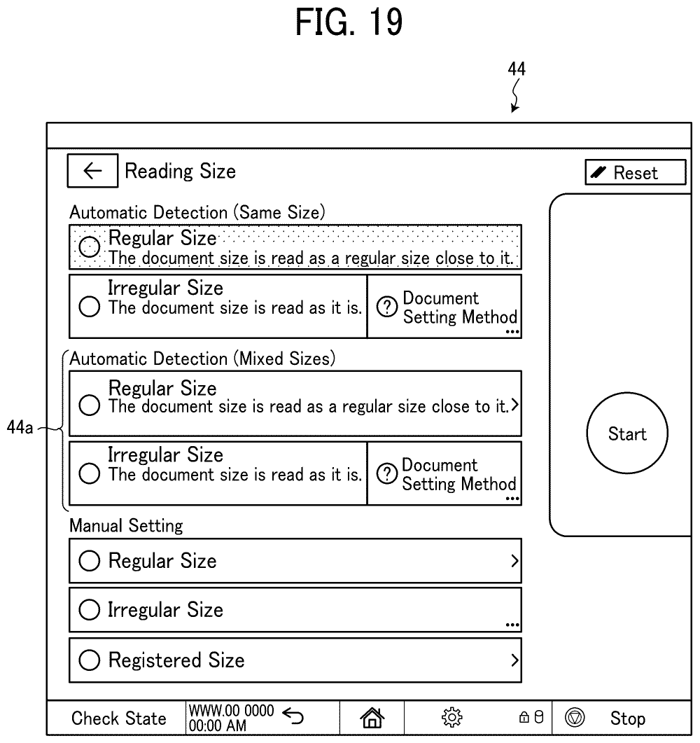

FIG. 19 is a diagram illustrating an example of a display form on the operation device 44. As illustrated in FIG. 19, the operation device 44 implements a user interface that allows the user to set in advance simultaneous reading of documents 100 of multiple sizes or to set a use method assumed for multiple-sized-document reading. In the example illustrated in FIG. 19, the operation device 44 allows the user to designate an “automatic detection (mixed sizes)” 44a as the reading size. When the “automatic detection (mixed sizes)” 44a is designated, the switching unit 411 determines that documents of multiple sizes are mixed.

The switching unit 411 switches whether to activate the mechanical inclination correction device 70 depending on whether an option in the “automatic detection (mixed sizes)” 44a is selected as the reading size on the operation device 44. For example, in a case where a corresponding option (e.g., reading multiple documents including an irregular-sized document) is selected, the mechanical inclination correction device 70 is disabled and the electronic inclination correction device 80 is activated.

As described above, in one embodiment, the operation device 44 guides the user to avoid document damage that is likely to occur due to the activation of the mechanical inclination correction device 70 when documents of multiple sizes are read. In another embodiment, the user may use the above-described option in the “automatic detection (mixed sizes)” 44a when the user does not desire to damage the document.

If the switching unit 411 determines that documents of multiple sizes are mixed and are to be read (Yes in step S1), the controller 41 disables the mechanical inclination correction device 70 and performs reading of an image of each of the documents (step S2).

Then, the switching unit 411 controls the electronic inclination correction device 80 (the feature value detector 431 and the inclination corrector 432) to perform electronic inclination correction on the read image (step S3).

When the documents 100 include a regular-sized document, the location through which the regular-sized document will pass along the conveyance path 23 is estimated. Thus, the arrangement of the members to be used in the mechanical inclination correction device 70 is determined in accordance with the estimated location of the document along the conveyance path 23. When the documents 100 include an irregular-sized document, however, it is difficult to estimate the location through which the irregular-sized document will pass along the conveyance path 23. Specifically, it is difficult to estimate the location through which a possibly severely damaged portion of the document, such as an edge of the document, will pass along the conveyance path 23. Thus, the document is more likely to be damaged than a regular-sized document depending on the combination of the arrangement of the members and the size of the document.

In the present embodiment, accordingly, in a case where the user of the image reading device 101 sets a setting for an irregular-sized document 100 on the operation device 44, inclination correction by the mechanical inclination correction device 70 is not performed to avoid possible damage to the document 100 due to the execution of the mechanical inclination correction.

Then, the controller 41 determines whether the next document to be read is absent (step S4).

When the controller 41 determines that the next document to be read is present (No in step S4), the controller 41 returns to step S2 and performs reading of an image of the next document. When the controller 41 determines that the next document to be read is absent (Yes in step S4), the controller 41 ends the process.

When the switching unit 411 determines that documents of multiple sizes are not mixed and documents of a single size are to be read (No in step S1), the controller 41 controls the mechanical inclination correction device 70 to perform mechanical inclination correction on a read document, such as a read image (step S5).

For example, the electronic inclination correction performed by the electronic inclination correction device 80 alone may fail to correct the inclination of the document and cause an error depending on the combination of the inclination of the document and the width of the image to be acquired. To address this error, the switching unit 411 performs control such that the mechanical inclination correction device 70 performs mechanical inclination correction at the time of reading single-sized documents that are less likely to be damaged due to the execution of mechanical inclination correction by the mechanical inclination correction device 70. This configuration allows the image reading device 101 to perform inclination correction while reducing the frequency of error occurrence as compared to correction performed by the electronic inclination correction device 80 alone.

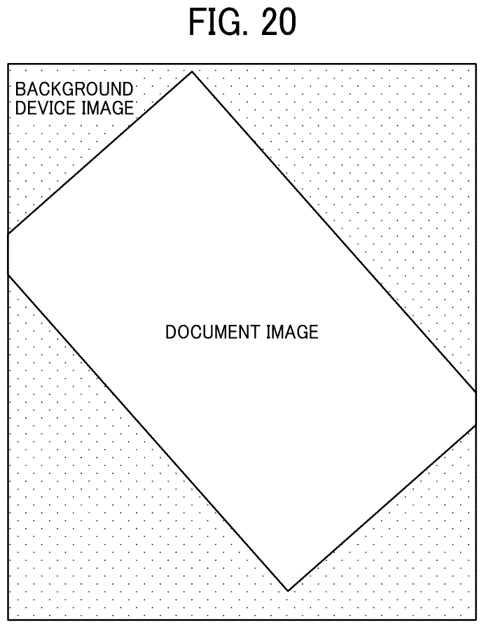

FIG. 20 is a diagram illustrating an example in which electronic inclination correction by the electronic inclination correction device 80 is not effective. One possible method for inclination estimation is to estimate an inclination of a document area from an upper left corner portion of the document area. In a case illustrated in FIG. 20, however, a corner of a document image is not detectable and accordingly the inclination of the document image is difficult to estimate, resulting in an error. This problem is raised in the related art. Another problem is that even if the inclination of the document image is successfully calculated, a lost portion of the document image is difficult to repair.

Then, the controller 41 performs reading of an image of the document (step S6).

Then, the controller 41 determines whether the next document to be read is absent (step S7). When the controller 41 determines that the next document to be read is present (No in step S7), the controller 41 returns to step S5 and performs reading of an image of the next document. When the controller 41 determines that the next document to be read is absent (Yes in step S7), the controller 41 ends the process.

This configuration enables correction for an inclination of documents of multiple sizes when the documents are set and reading of the documents while reducing the possibility of damage to the documents during reading.

A side benefit of using the electronic inclination correction performed by the electronic inclination correction device 80 is quietness during reading of an image. The mechanical inclination correction performed by the mechanical inclination correction device 70 involves, for example, an abutment operation. During the abutment operation, a collision sound between the document 100 and a member for abutment (e.g., the pullout roller pair 24a) is produced, resulting in noise. Such noise is not generated when the electronic inclination correction device 80 is used instead of the mechanical inclination correction device 70. Thus, quietness is achieved.

As described above, according to the present embodiment, in case where the documents 100 are of multiple sizes, the electronic inclination correction device 80 is used instead of the mechanical inclination correction device 70. In the configuration of the image reading device of the related art, as described above, when the mechanical inclination correction device 70 is used at the time of reading documents of mixed sizes, document damage is likely to occur. However, in the configuration of the image reading device 101 according to the present embodiment, the electronic inclination correction performed by the electronic inclination correction device 80 is used, instead of the mechanical inclination correction performed by the mechanical inclination correction device 70, at the time of reading documents of mixed sizes. This configuration can provide a read image corrected for the inclination of each of the documents during conveyance while reducing damage to the documents. In addition, as a side effect, better quietness is provided when the mechanical inclination correction performed by the mechanical inclination correction device 70 is not used.

In the present embodiment, the mechanical inclination correction performed by the mechanical inclination correction device 70 is used in a case where the documents 100 are of the same size but not of multiple sizes. However, the present embodiment is not limited to this configuration. In another configuration, in a case where the documents 100 are of the same size but not of multiple sizes, the switching unit 411 may use both the mechanical inclination correction device 70 and the electronic inclination correction device 80.

There is a constraint on an inclination of the documents 100 that can be addressed by electronic inclination correction using the electronic inclination correction device 80. Accordingly, in one example, the mechanical inclination correction device 70 performs mechanical inclination correction to reduce an inclination of a document in advance, and thereafter the electronic inclination correction device 80 performs electronic inclination correction. This configuration allows a wider range of inclination correction than an image reading device in which either the mechanical inclination correction device 70 or the electronic inclination correction device 80 is used.

### Second Embodiment

Next, a second embodiment is described.

In the second embodiment, unlike the first embodiment, the detection result of the document width sensor 52 is used to determine whether documents of multiple sizes are mixed. Accordingly, the mixed-size document determination is not performed first, but is performed in the middle of an automatic mode. In the following description of the second embodiment, the description of portions that are the same as those in the first embodiment is omitted, and the differences from the first embodiment are described.

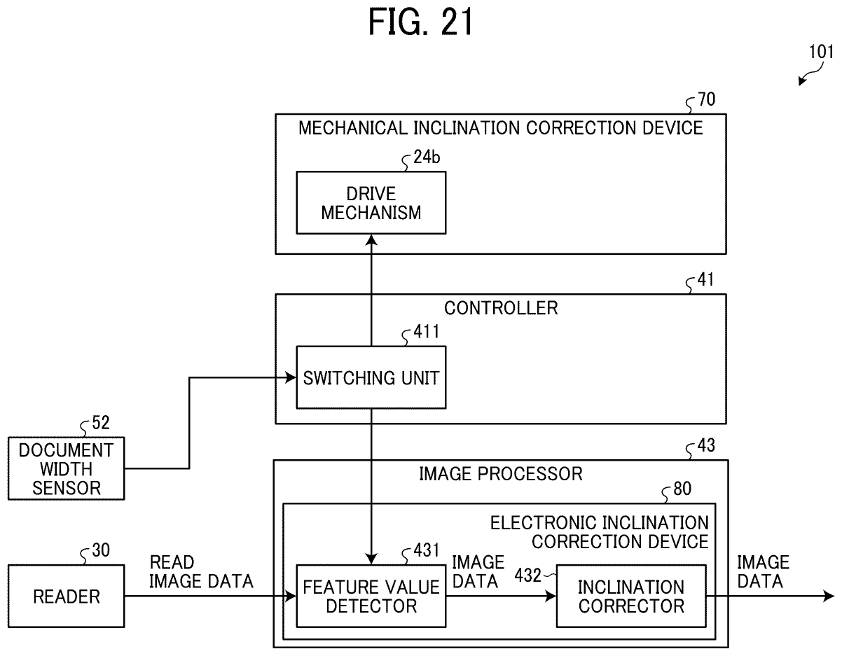

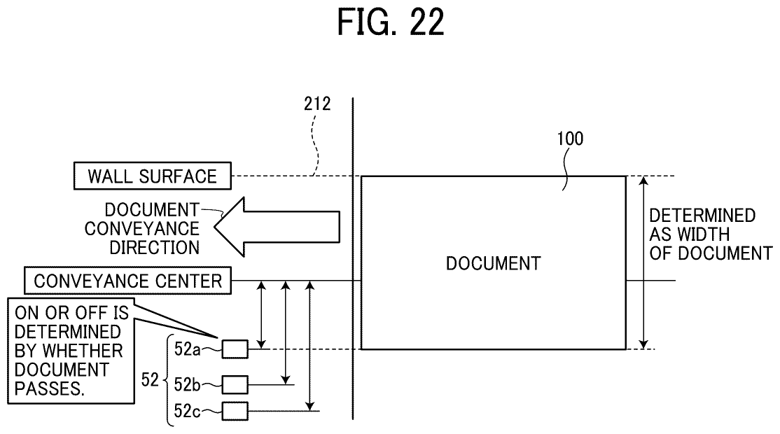

FIG. 21 is a block diagram illustrating a functional configuration of components of an image reading device 101 according to the second embodiment. FIG. 22 is a diagram illustrating an example arrangement of the document width sensor 52. As illustrated in FIG. 21, the image reading device 101 includes the document width sensor 52. The output of the document width sensor 52 is input to the controller 41. As illustrated in FIG. 22, the document width sensor 52 includes a plurality of light-receiving elements (52a, 52b, and 52c) serving as sensors. In one example, the light-receiving elements (52a, 52b, and 52c) are each arranged in the width direction of documents 100 in accordance with the size of a standard document among the documents 100 with respect to a side guide plate 212 serving as a document placement reference. The document width sensor 52 is provided at a position facing each of the documents 100 with the conveyance path 23 interposed therebetween, and detects the width of the document 100 based on a light-receiving result from the light with which the document 100 is irradiated. The length of each of the documents 100 in the conveyance direction is detected from a motor pulse generated when the contact sensor 51 provided near the pullout roller pair 24a reads the leading and trailing edges of the document 100.

As described above, the image reading device 101 according to the present embodiment is configured to detect the width of each of the documents 100 using the document width sensor 52.

As illustrated in FIG. 22, in one example, the document width sensor 52 includes the plurality of light-receiving elements (52a, 52b, and 52c) arranged in the width direction of the documents 100. The light-receiving elements (52a, 52b, and 52c) of the document width sensor 52 are placed at positions that allow determination of which standard size each of the documents 100 corresponds to. When a standard-size document 100 is fed, one of the light-receiving elements (52a, 52b, and 52c) of the document width sensor 52 responds to the document 100, and the size of the document 100 is determined from position information of the responding light-receiving element.

The document width sensor 52 is provided upstream of the reader along the conveyance path 23 and estimates the size of each of the documents 100 from the value of a corresponding one of the light-receiving elements (52a, 52b, and 52c) of the document width sensor 52.

The switching unit 411 determines, based on the sizes of the documents 100 obtained from the document width sensor 52, that the documents 100 are of multiple sizes. More specifically, in response to one image being read, the switching unit 411 compares the following sizes: the size of the read document obtained from the document width sensor 52; and the size of the document to be read next, which is obtained from the document width sensor 52. If the two sizes are different, the switching unit 411 determines to read multiple-sized documents, and performs control to disable the mechanical inclination correction device 70.

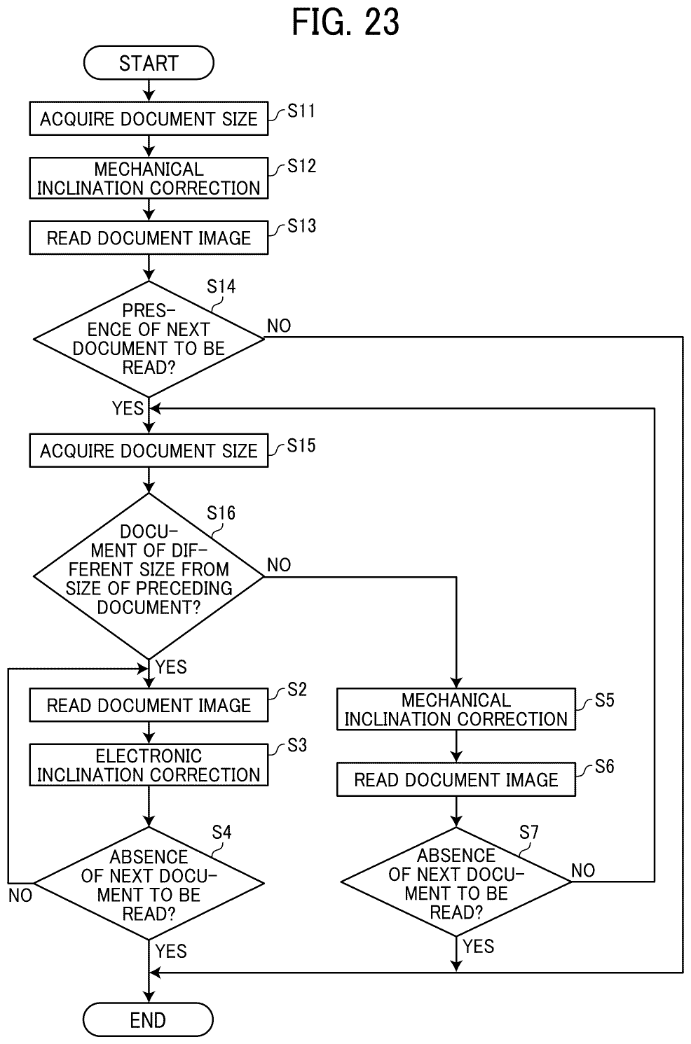

FIG. 23 is a flowchart schematically illustrating an image reading process according to the present embodiment.

As illustrated in FIG. 23, when the first document among the documents 100 is read, the switching unit 411 acquires the size of the read document 100 from the document width sensor 52 (step S11). The acquired size of the read document 100 is used when the next document 100 to be read is present.

Then, the switching unit 411 controls the mechanical inclination correction device 70 to perform mechanical inclination correction on a read document such as a read image (step S12).

Subsequently, the controller 41 performs reading of an image of the document 100 (step S13), and then determines whether the next document 100 to be read is present (step S14).

When the controller 41 determines that the next document 100 to be read is not present (No in step S14), the controller 41 ends the process.

On the other hand, when the controller 41 determines that the next document 100 to be read is present (Yes in step S14), the controller 41 acquires, from the document width sensor 52, the size of the document 100 to be read next (step S15).

Then, the switching unit 411 compares the size of the document 100 to be read next with the size of the document 100 that has been read, and determines whether the size of the document 100 to be read next is different from the size of the document 100 that has been read (step S16).

If the switching unit 411 determines that the size of the document 100 to be read next is different from the size of the document 100 that has been read (YES in step S16), the controller 41 determines that documents of multiple sizes are mixed, disables the mechanical inclination correction device 70 to avoid document damage, and performs reading of an image of the document 100 (step S2).

Then, the switching unit 411 controls the electronic inclination correction device 80 (the feature value detector 431 and the inclination corrector 432) to perform electronic inclination correction on the read image (step S3).

Then, the controller 41 determines whether the next document to be read is absent (step S4).

When the controller 41 determines that the next document to be read is present (No in step S4), the controller 41 returns to step S2 and performs reading of an image of the next document. When the controller 41 determines that the next document to be read is absent (Yes in step S4), the controller 41 ends the process. In other words, the process of “reading a document image” followed by “performing electronic inclination correction” is repeated until the next document to be read is no longer present. That is, the mechanical inclination correction is not used in this loop.

On the other hand, if the switching unit 411 determines that the size of the document 100 to be read next is not different from the size of the document 100 that has been read (No in step S16), the controller 41 determines that at least documents 100 up to the document 100 to be read next are of a single size. Thus, the controller 41 controls the mechanical inclination correction device 70 to perform mechanical inclination correction on the read image (step S5).

Then, the controller 41 performs reading of an image of the document (step S6).

Then, the controller 41 determines whether the next document to be read is absent (step S7). When the controller 41 determines that the next document to be read is present (No in step S7), the controller 41 returns to step S15 and acquires the size of the document 100 to be read next. When the controller 41 determines that the next document to be read is absent (Yes in step S7), the controller 41 ends the process.

As described above, according to the present embodiment, in response to the presence of documents 100 of multiple different sizes being determined after the first several documents are brought into abutment for registration, it is possible to read an image electronically corrected for an inclination while avoiding possible damage to the documents 100 due to the use of the mechanical inclination correction device 70 during reading of the documents 100.

In the first embodiment, in response to a predetermined operation being performed on the operation device 44, the image reading device 101 determines that the documents 100 are of multiple different sizes and operates. In the present embodiment, the document width sensor 52 automatically determines that the documents 100 are of multiple sizes, without a configuration in which a predetermined operation is performed on the operation device 44. The present embodiment achieves effects similar to those of the configuration in which a predetermined operation is performed on the operation device 44, and provides more enhanced convenience.

In the present embodiment, as illustrated in FIG. 22, the document width sensor 52 includes the plurality of light-receiving elements (52a, 52b, and 52c) each arranged in the width direction of the documents 100 in accordance with the size of a standard document among the documents 100 with respect to the side guide plate 212. However, the present embodiment is not limited to this configuration.

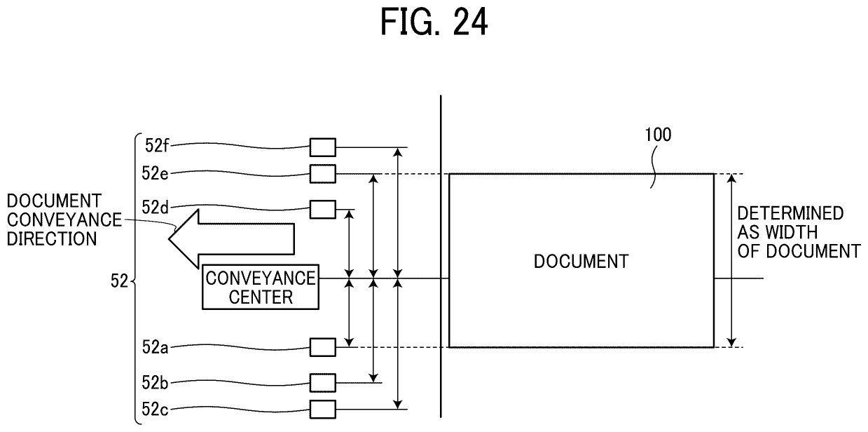

In another example, as illustrated in FIG. 24, the document width sensor 52 may include light-receiving elements (52a, 52b, 52c, 52d, 52e, and 52f) such that some of the light-receiving elements (52a, 52b, 52c, 52d, 52e, and 52f) are disposed to the left of the conveyance path 23 with respect to the conveyance center, and the other light-receiving elements are disposed to the right of the conveyance path 23 with respect to the conveyance center.

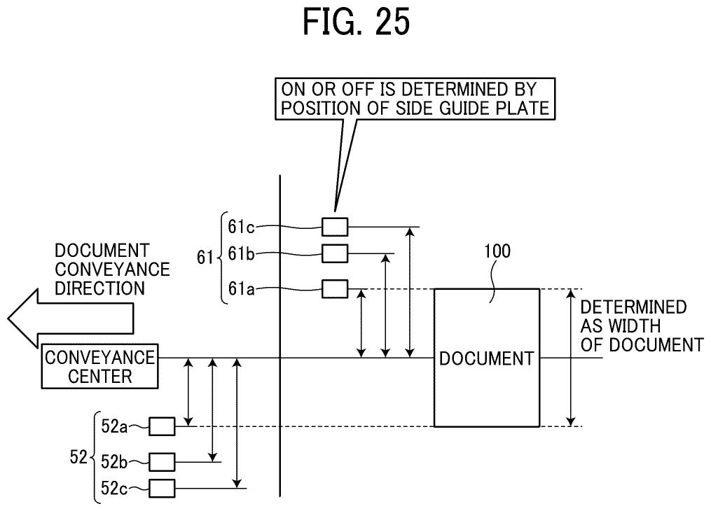

In another example, as illustrated in FIG. 25, the document width sensor 52 may include a plurality of light-receiving elements (52a, 52b, and 52c) arranged side by side along the conveyance path 23, and a guide-plate sensor 61 including a plurality of light-receiving elements (61a, 61b, and 61c) may be disposed adjacent to the side guide plate 212 of the tray 21 (see FIG. 2) to detect the position of the side guide plate 212 that has been slid.

The program to be executed by the image forming apparatus 1 according to each of the embodiments described above is recorded on a computer-readable recording medium such as a compact disc read only memory (CD-ROM), a flexible disk (FD), a compact disc recordable (CD-R), or a digital versatile disc (DVD) in an installable or executable file format and is provided.

The program to be executed by the image forming apparatus 1 according to each of the embodiments described above may be stored in a computer connected to a network such as the Internet and may be provided by being downloaded via the network. The program to be executed by the image forming apparatus 1 according to each of the embodiments described above may be provided or distributed via a network such as the Internet. The program to be executed by the image forming apparatus 1 according to each of the embodiments described above may be provided by being incorporated in a read only memory (ROM) or the like in advance.

The program to be executed by the image forming apparatus 1 according to each of the embodiments described above has a module configuration including the components described above (e.g., the switching unit 411). As actual hardware, a CPU (or processor) reads the program from a storage medium and executes the program such that the components described above are loaded onto a main storage device and the switching unit 411 is implemented on the main storage device.

The reading device according to each of the above-described embodiments of the present disclosure is applied to, for example, but not limited to, an MFP having at least two of copying, printing, scanning, and facsimile functions. In another example, the reading device may be applied to any image forming apparatus such as a copier, a printer, a scanner, or a facsimile machine.

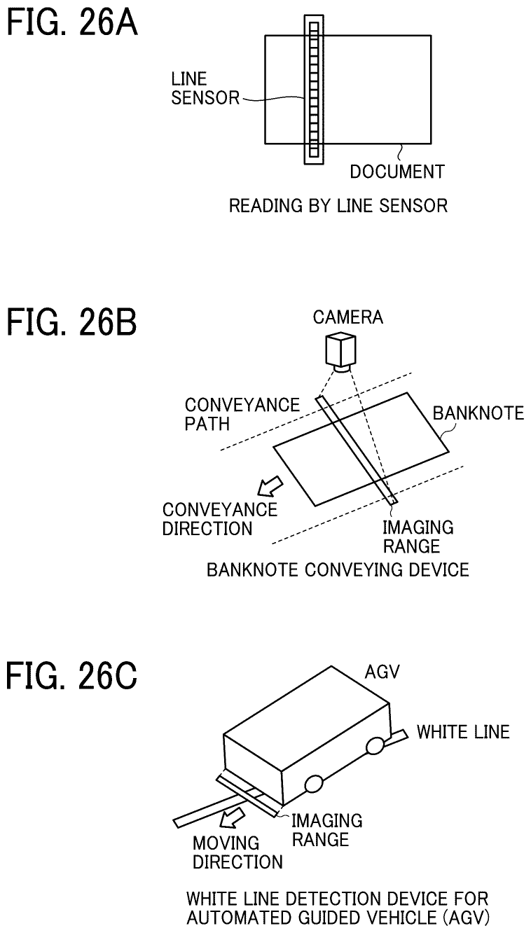

In each of the embodiments described above, by way of example but not limitation, the image reading device 101 of the image forming apparatus 1 is used as a reading device. The term “reading device” refers to any device configured to acquire a reading level, such as a line sensor using an equal-magnification optical system (contact image sensor (CIS) type) illustrated in FIG. 26A, as well as a device that reads an image. The device illustrated in FIG. 26A reads information on a plurality of lines by moving a line sensor or a document.

In another example, the reading device may be applied to a banknote conveying device illustrated in FIG. 26B. In another example, the reading device may be applied to a white line detection device for an automated guided vehicle (AGV) illustrated in FIG. 26C.

The subject of the banknote conveying device illustrated in FIG. 26B is a banknote. The feature value detected by the banknote conveying device is used in, for example, a process of correcting an image itself. That is, the banknote conveying device illustrated in FIG. 26B recognizes the inclination of the banknote by edge detection and performs skew correction using the recognized inclination.

The subject of the white line detection device for the AGV illustrated in FIG. 26C is a white line. The feature value detected by the white line detection device for the AGV is used to, for example, determine the moving direction of the AGV. That is, the white line detection device for the AGV performs edge detection to recognize an inclination of a white-line area. and determines the moving direction of the AGV using the recognized inclination. The white line detection device for the AGV may correct the moving direction in accordance with the position and orientation of the AGV in a subsequent process. For example, the driving of the AGV may be stopped in response to detection of a white line having a thickness different from a known thickness.

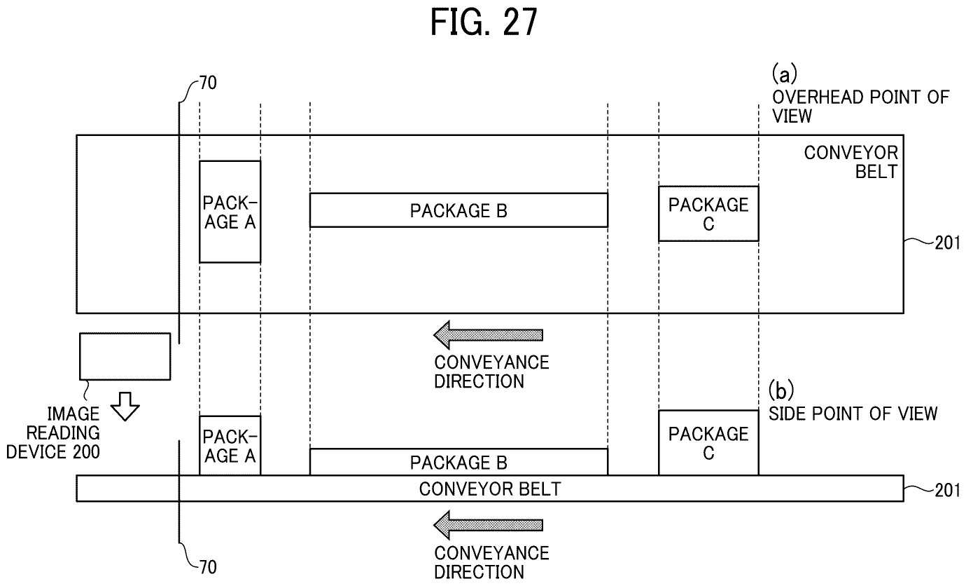

FIG. 27 is a diagram illustrating a reading device according to another modification. In the example illustrated in FIG. 27, the reading device is applied to an image reading device 200 used to package products at a production site or the like.

The subjects of the image reading device 200 illustrated in FIG. 27 are packages A, B, and C having different sizes. The packages A, B, and C are objects being transported. As illustrated in FIG. 27, when the packages A, B, and C having different sizes are conveyed by a conveyor belt 201, the image reading device 200 detects feature values (edges) of the packages A, B, and C to detect the widths of the packages A, B, and C. In the detection of the feature values of the packages A, B, and C, visible light is effective for a black package, and invisible light is effective for a white package.

In this case, the background device 26 may be a surface of the conveyor belt 201, or a dedicated background device 26 may be disposed such that the reading position of the image reading device 200 is set to a gap in the conveyor belt 201.

In the image reading device 200, the switching unit 411 switches whether to use each of the mechanical inclination correction device 70 and the electronic inclination correction device 80 for, for example, the packages A, B, and C being conveyed. More specifically, the switching unit 411 uses the mechanical inclination correction device 70 when the packages A, B, and C being conveyed are of the same size but not of multiple sizes, and uses the electronic inclination correction device 80 when the packages A, B, and C being conveyed are of multiple sizes.

For example, the user of the image reading device 200 can select whether to enable or disable the mechanical inclination correction by performing a predetermined operation on the operation device 44. Thus, for example, in a case where a package being conveyed is a “fragile” package, possible damage to a small package due to the mechanical inclination correction performed the mechanical inclination correction device 70 can be avoided.

In the embodiments described above, electronic inclination correction is used, instead of mechanical inclination correction, at the time of reading subjects of mixed sizes. This configuration can provide a read image corrected for the inclination of each of the subjects during conveyance while reducing damage to the subjects.

Aspects of the present disclosure are, for example, as follows.

In a first aspect, a reading device includes an illumination device, an imaging device, a conveyance device, a first inclination correction device, a second inclination correction device, and a switching unit. The illumination device emits light to a subject. The imaging device receives light reflected from the subject and generates an image. The conveyance device conveys the subject to a reading position of the imaging device. The first inclination correction device mechanically corrects an inclination of the subject. The second inclination correction device electronically corrects an inclination of the image obtained from the imaging device. The switching unit switches between the first inclination correction device and the second inclination correction device. The switching unit uses the first inclination correction device in a case where the subject includes subjects of a single size but does not include subjects of multiple sizes. The switching unit uses the second inclination correction device in a case where the subject includes subjects of multiple sizes.

According to a second aspect, in the reading device of the first aspect, the switching unit further use the second inclination correction device in a case where the subject includes subjects of a single size but does not include subjects of multiple sizes.

According to a third aspect, the reading device of the first aspect or the second aspect further includes an operation device. The switching unit determines that the subject includes subjects of multiple sizes, and uses the second inclination correction device in response to a predetermined operation being performed on the operation device.

According to a fourth aspect, in the reading device of the third aspect, the switching unit uses the second inclination correction device in response to an operation of setting an irregular-sized subject as the subject being performed on the operation device.

According to a fifth aspect, the reading device of any one of the first aspect to the fourth aspect further includes a document size detector provided upstream of the imaging device in a direction of conveyance of the subject to acquire a size of the subject. The switching unit determines that the subject includes subjects of multiple sizes, based on a size of a read subject and a size of a subject to be read next. The size of the read subject and the size of the subject to be read next are obtained from the document size detector.

According to a sixth aspect, in the reading device of any one of the first aspect to the fifth aspect, the subject includes an object being transported.

In a seventh aspect, an image processing apparatus includes the reading device of any one of the first aspect to the sixth aspect and an image forming device.

In an eighth aspect, a reading method is performed by a reading device including an illumination device, an imaging device, and a conveyance device. The illumination device emits light to a subject. The imaging device receives light reflected from the subject and generates an image. The conveyance device conveys the subject to a reading position of the imaging device. The reading method includes executing a first inclination correction process to mechanically correct an inclination of the subject; executing a second inclination correction process to electronically correct an inclination of the image obtained from the imaging device; and switching whether to execute each of the first inclination correction process and the second inclination correction process. The switching executes the first inclination correction process in a case where the subject includes subjects of a single size but does not include subjects of multiple sizes, and executes the second inclination correction process in a case where the subject includes subjects of multiple sizes.

In a ninth aspect, a program causes a computer that controls a reading device including an illumination device, an imaging device, a conveyance device, a first inclination correction device, and a second inclination correction device to function as a switching unit. The illumination device emits light to a subject. The imaging device receives light reflected from the subject and generates an image. The conveyance device conveys the subject to a reading position of the imaging device. The first inclination correction device mechanically corrects an inclination of the subject. The second inclination correction device electronically corrects an inclination of the image obtained from the imaging device. The switching unit between the first inclination correction device and the second inclination correction device. The switching unit uses the first inclination correction device in a case where the subject includes subjects of a single size but does not include subjects of multiple sizes. The switching unit uses the second inclination correction device in a case where the subject includes subjects of multiple sizes.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A reading device comprising:
a light source to emit light to a subject;
an imaging device to receive light reflected from the subject and generate an image;
a first inclination correction device to mechanically correct an inclination of the subject;
a second inclination correction device to electronically correct an inclination of the image obtained at the imaging device; and
circuitry configured to:
switch to use between the first inclination correction device and the second inclination correction device,
wherein, in a case where the subject includes subjects of a single size but does not include subjects of multiple sizes, the circuitry is configured to switch to use the first inclination correction device, and
in a case where the subject includes subjects of multiple sizes, the circuitry is configured to switch to use the second inclination correction device.

2. The reading device according to claim 1, wherein
in a case where the subject includes subjects of a single size but does not include subjects of multiple sizes, the circuitry is configured to use the second inclination correction device in addition to the first inclination correction device.

3. The reading device according to claim 1, further comprising an operation device, wherein
the circuitry is configured to determine that the subject includes subjects of multiple sizes and use the second inclination correction device in response to a predetermined operation being performed on the operation device.

4. The reading device according to claim 3, wherein
the circuitry is configured to use the second inclination correction device in response to an operation of setting an irregular-sized subject as the subject being performed on the operation device.

5. The reading device according to claim 1, further comprising:
a conveyer to convey the subject to be read by the imaging device; and
a subject size detector upstream of the imaging device in a direction of conveyance of the subject to acquire a size of the subject, wherein
the circuitry is configured to determine that the subject includes subjects of multiple sizes, based on a size of a read subject and a size of a subject to be read next, the size of the read subject and the size of the subject to be read next being obtained from the subject size detector.

6. The reading device according to claim 1, wherein the subject includes an object being transported.

7. An image processing apparatus comprising:
the reading device according to claim 1; and
an image forming device to form the image.

8. A reading method comprising:
emitting light to a subject;
reading, by an imaging device, light reflected from the subject to generate an image; and
switching to use between a first inclination correction device to mechanically correct an inclination of the image obtained at the imaging device and a second inclination correction device to electronically correct an inclination of the image obtained at the imaging device,
the switching including
switching to use the first inclination correction device in a case where the subject includes subjects of a single size but does not include subjects of multiple sizes, and
switching to use the second inclination correction device in a case where the subject includes subjects of multiple sizes.

9. A non-transitory recording medium storing a plurality of instructions which, when executed by one or more processors, causes the processors on a reading device to perform a method,
the reading device including:
a light source to emit light to a subject;
an imaging device to receive light reflected from the subject and generate an image;
a first inclination correction device to mechanically correct an inclination of the subject; and
a second inclination correction device to electronically correct an inclination of the image obtained at the imaging device,
the method comprising:
switching to use between the first inclination correction device and the second inclination correction device,
the switching including
switching to use the first inclination correction device in a case where the subject includes subjects of a single size but does not include subjects of multiple sizes, and
switching to use the second inclination correction device in a case where the subject includes subjects of multiple sizes.
